(19) United States
(12) Patent Application Publication
(10) Pub. No.: US 2011/0014257 A1
(43) Pub. Date: Jan. 20, 2011

(54) BIODEGREADABLE DEVICE WITH SLOW-RELEASE OF VOLATILE PRODUCTS HAVING AN ATTRACTANT ACTION FOR THE CONTROL OF INSECTS

(75) Inventors: Franco Rama, Busto Arsizio Va (IT); Franca Reggiori, Novara No (IT); Alberto Albertini, San Pietro In Casale Bo (IT)

Correspondence Address: HEDMAN & COSTIGAN, P.C., 1230 AVENUE OF THE AMERICAS, 7th floor, NEW YORK, NY, 10020, US

(73) Assignee: ISAGRO S.P.A., MILAN MI (IT)

(21) Appl. No.: 12/735,348

(22) PCT Filed: Jan. 16, 2009
(86) PCT No.: PCT/IB2009/000069

§ 371 Date: Sep. 9, 2010

(30) Foreign Application Priority Data
Jan. 18, 2008 (IT) MI2008A000077

(51) Int. Cl. A01N 25/08; A01N 37/08; A01P 7/04; B05D 1/36

(52) U.S. Cl. 424/409; 514/529; 424/84; 427/177

(57) ABSTRACT

The invention describes a biodegradable device with a slow-release of volatile products having an attractant action with respect to insects, which can be applied to a wide range of crops.

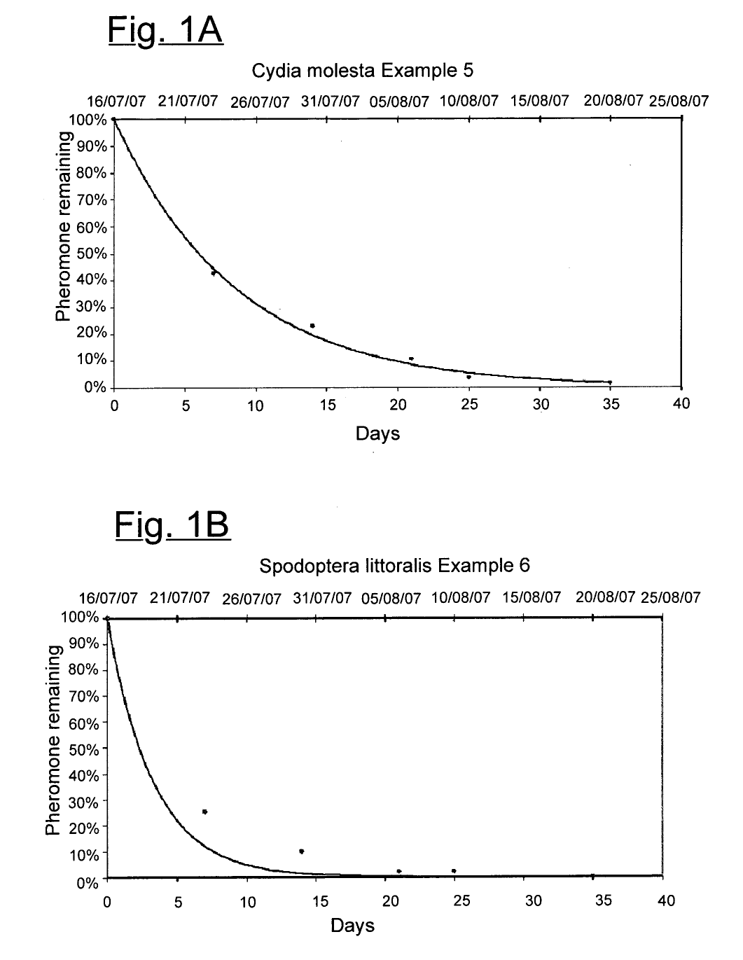

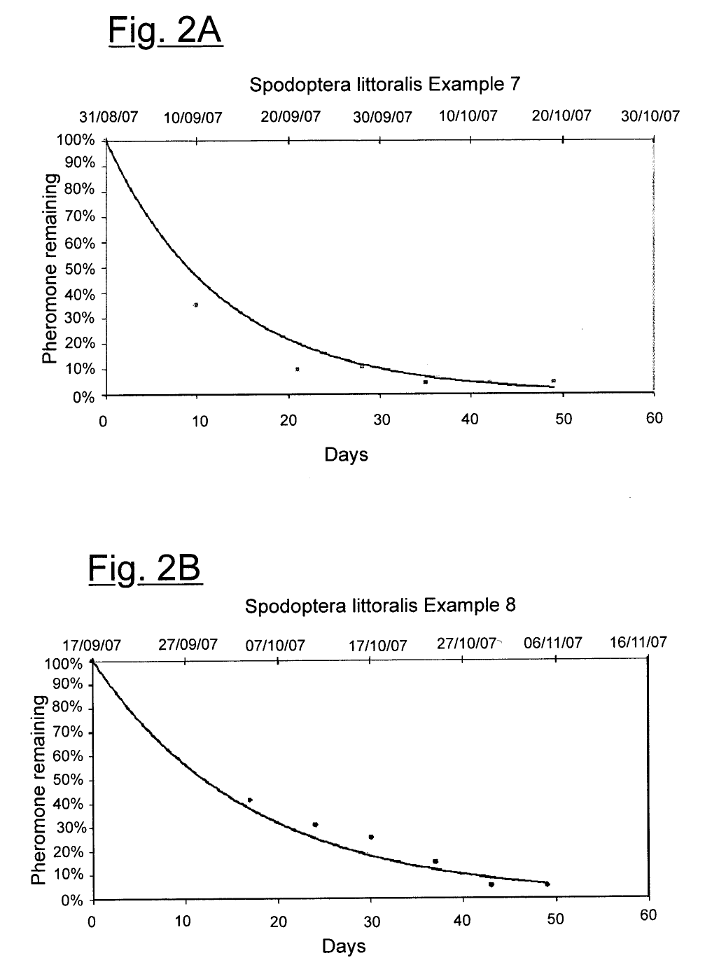

The present invention relates to a biodegradable device with a slow release of volatile products which attracts insects.

More specifically, the present invention relates to a pheromone dispenser which has the characteristic of being biodegradable and of releasing, at a slow and controlled rate, volatile products for being used in the field of agriculture for the protection of a wide range of crops from parasitic insects.

Pheromones have become extremely important in the research of new methods for the control of insects which are harmful to agrarian crops; compared with conventional products, these substances have the advantage of having a considerable selectivity towards a species or a limited number of similar species, with no danger for harmless or useful fauna.

With the help of pheromones, it is therefore possible to fight a specific parasitic insect without disturbing the biological equilibrium of the infested area.

Sexual synthetic pheromones, for example, are used for monitoring the development of parasite populations and also for directly controlling harmful species preventing their mating.

The first type of application (monitoring) allows fluctuations in the populations of parasites to be followed, by means of periodical surveys of captures in specific traps, observing their biological cycle and thus being able to foresee whether a possible “damage threshold” is being reached and to decide the moment of intervention.

In the second type of application, the sexual pheromones can partially or totally substitute insecticides with a direct control of harmful species by interfering in their reproduction activities.

There are three techniques used for this purpose: mass trapping, confusion and disorientation.

The first consists in attracting and capturing the largest number of adult insects by means of particular traps baited with the pheromone.

The second technique is effected by saturating the environment with considerable quantities of active principle (not less than 75-100 g/ha), so as to shield the natural attraction of females thus preventing them from being identified by the males.

The third technique consists in the creation of predominant pheromone traces with respect to the natural attraction of female insects, by the distribution of a sufficiently high number of dispensers with a reduced charge of the active principle.

The male insects are thus compelled to follow false pheromone traces and spend most of their time visiting the various supply points instead of the females present in the area to be protected.

This latter method consequently makes it possible to operate with low dosages of pheromones, contrary to what is required by the sexual confusion method.

In both the confusion and disorientation technique, the male insects are not only unable to recognize the natural call of the females, but are not even capable of following the artificial call effected by the monitoring traps installed within the treated area. This allows the efficacy and persistence of the treatment to be easily controlled: in the presence of confusion or disorientation, in fact, captures in traps are zero.

In the confusion technique, dispensers are used, whose active principle is incorporated in various kinds of substrates which regulate its release rate and persistence.

This system is effected, for example, with capillaries having an open end from which the active principle volatizes (U.S. Pat. No. 4,017,030).

Alternative embodiments are described in patents EP 496,102 and EP 683,977 and U.S. Pat. No. 5,503,839, where the active principle is contained in ampoules or tubes made of polymeric material from which it volatilizes by permeability through the walls.

EP 402,826 describes a process for the preparation of an ethylene copolymer filled with 5-90% by weight of a non-fibrous carbohydrate, by the extrusion of a mixture of the components and the use of the material thus prepared as pheromone dispenser.

A further embodiment is described in Italian patent IT 1,187,647 (patent application MI 20054 A/85) in which the pheromone is contained in a device which activates both a disorientation action and an attraction and elimination action of adult insects. The device consists of a substrate of fibres and/or fibrils containing a pheromone, adsorbed or dispersed therein, partially coated by a layer impermeable to the pheromone consisting of aluminum or nylon, polyester or polyvinyl chloride film.

The systems described above, however, have the disadvantage of not being biodegradable, which leads to an accumulation of polymeric materials in the environment treated and in addition, the material is not impregnated with the pheromones.

Another example is provided in DE 29905603 which describes a method for the protection of plants from insects with the use of pheromones in small containers based on biodegradable material (i.e. gelatin, lignin, cellulose). Also in this case, the material is not impregnated with pheromones as the containers require considerable manual labour in distributing them in the area of interest.

A further embodiment is described in patent EP 1,220,607 in which the device consists of a biodegradable material based on starches and thermoplastic polymers impregnated with pheromones and moulded in the form of a hook or spiral. In this latter example, the main disadvantage lies in the high number of dispensers to be manually distributed and consequently considerable manual labour.

Furthermore, none of the methods of the known art described above can be easily used for a wide range of crops, i.e. vegetables or flowers, as, unlike what occurs for fruit trees in which the dispensers are applied directly to the branches of the trees, these areas generally lack the supports for being able to attach an adequate number of dispensers which are uniformly distributed.

An objective of the present invention is to provide a biodegradable device which allows a slow and controlled release into the air of volatile substances, such as pheromones, which exert a prevalently disorientating action with respect to harmful insects, and at the same time allows a reduction in the installation times and costs in the areas to be treated and which can be easily used for a wide range of crops, i.e. vegetables or flowers, either in greenhouses or open fields.

It has now been surprisingly found that these and other objectives are achieved by means of a device consisting of an internal structure made of biodegradable material based on cellulose, impregnated with a volatile substance or a mixture of volatile substances, such as pheromones, and an outer coating made of a biodegradable material based on starches and thermoplastic polymers, said device being extruded in the form of a continuous thread.

In the specific case of the fight against insects, the pheromones which can be used derive from alcohols, acetates and aldehydes containing from 10 to 18 carbon atoms, mono-, bi- and tri-unsaturated and mixtures thereof, such as for example the pheromones of Cydia molesta, Anarsia lineatella, Cydia funebrana, Cydia pomonella, Lobesia botrana, Spodoptera littoralis, Spodoptera exigua, Spodoptera frugiperda, Heliothis armigera.

The device for the invention can also be used for the controlled release of other volatile products such as for example tert-butyl (±)-4-chloro-2-methyl cyclohexane carboxylate or its isomer tert-butyl (±)-5-chloro-2-methyl cyclohexane carboxylate (Trimedlure®); this product exerts an attractant action with respect to fruit flies, Ceratitis capitata and can be used for the production of traps for both monitoring and massive captures.

As already mentioned, a further advantage of the present invention is represented by the possibility of using the system on vegetable crops (such as lettuces, spinach, cabbages, artichokes, basil, strawberries, etc.) and flowers (such as cyclamens), both in greenhouses and in open fields for defense against harmful noctuids such as Spodoptera littoralis, Spodoptera exigua, Spodoptera frugiperda, Mamestra brassicae, Heliothis armigera.

For the production of the device of the invention, any cellulose-based biodegradable material containing the pheromone or mixture of pheromones can be used, for the internal part, and any biodegradable material based on starches and thermoplastic polymers, for the coating part.

For the internal part, cellulose materials such as, for example, paper threads or cords for agricultural use and for pastimes, having a diameter ranging from 1 to 3 mm, wound in bobbins having a variable length, are preferably used. The thread has a diameter preferably ranging from 1.3 to 1.6 mm.

Materials based on maize starch and thermoplastic polymers, capable of being rapidly biodegraded or composted and which can be extruded without any particular problems, are preferably used for the external coating.

Examples of these materials are those described in European patents EP 539,541, EP 0327505, EP 947559 and known with the trade-name of Mater-Bi® (Novamont S.p.A.).

These materials can be obtained by the mixing, under suitable temperature and pressure conditions, of a starch-based component and a thermoplastic synthesis polymer selected from one of the following groups:

a) homopolymer of aliphatic hydroxy acids having from 2 to 24 carbon atoms, the corresponding lactones and lactides;
b) copolymers of aliphatic hydroxy acids having from 2 to 24 carbon atoms, the corresponding lactones and lactides, with monomers selected from the group consisting of aliphatic hydroxy acids having from 2 to 24 carbon atoms, different from those forming the first monomer, the corresponding lactones and lactides, aromatic hydroxy acids, aliphatic or aromatic isocyanates;
c) block or branched copolymers among the homopolymers a) or copolymers b), and one or more of the following components: i) cellulose or modified cellulose; ii) amylose, amylopectin, natural or modified starches; iii) polymers deriving from the reaction of diols, or polymers having terminal diol groups, with bifunctional isocyanates, with bifunctional epoxides, dicarboxylic acids, anhydrides; iv) polyurethanes, polyamide-urethanes from diisocyanates and amino-alcohols, polyamides, polyester-amides from dicarboxylic acids and amino-alcohols, polyester-urea from amino acids and diesters of glycols; v) polyhydroxylated polymers (such as polyvinyl alcohols), ethylene-vinyl alcohol copolymers, polysaccharides; vi) polyvinyl pyrrolidone-vinyl acetate copolymers, polyethyl-oxazolines; vii) ionomeric polymers such as polyacrylates and polymethacrylates;
d) polyesters obtained from monomers or co-monomers defined under items a) and b), improved by means of chain extenders such as isocyanates, epoxides, phenyl esters and aliphatic carbonates;
e) polyesters obtained from monomers or co-monomers defined under items a) and b), partially crosslinked by means of polyfunctional acids such as trimellitic and pyromellitic acid, polyisocyanates and polyepoxides.

The device has the form of a core wire having a length varying from 20 to 200 meters, wound in bobbins. The length of 100 meters is preferred to facilitate application.

The release rate of the pheromone is influenced by the thickness of the coating material. In general, coatings having a thickness ranging from 0.2 to 3 mm allow acceptable release rates, whereas optimal rates can be obtained with coatings having a thickness ranging from 0.7 to 1.5 mm.

The device of the present invention can be prepared by impregnating the bobbins of paper thread with a solution of pheromone or a blend of pheromones in a suitable low-boiling solvent, manually by immersion or semi-automatically using suitable equipment, for the dyeing of yarns, for example.

The pheromone charge depends on the concentration of the impregnating solution, ranging from 5 to 50 g/litre, preferably between 15 and 25 g/litre.

Examples of solvents which can be used are: methanol, dichloromethane, Freon®, hexane.

The impregnation is effected at temperatures ranging from 20 to 40° C. and for a time ranging from 30 seconds to 30 minutes, preferably from 2 to 15 minutes.

The impregnated thread is subsequently coated with biodegradable material based on starches and thermoplastic polymers, by extrusion at temperatures ranging from 100 to 200° C., preferably from 140 to 160° C.; after cooling, the coated thread is wound into bobbins having lengths varying from 20 to 200 metres, preferably from 80 to 120 metres. According to the application requirements, the bobbins can be subsequently cut and applied in pieces having any length, for example varying from 1 metre to several tens of metres.

The pheromone content per linear metre of thread ranges from 5 to 60 mg/metre, preferably from 15 to 25 mg/metre.

The device can be applied adopting various procedures, depending on the type of crop to be protected: in the case of fruit trees, the threads are preferably positioned between the trees, at a height preferably corresponding to their upper third, and fixed to the extremes; in the case of greenhouses, the threads can be directly bound to the supporting rods of the structures, at a variable height depending on the crop, preferably at 30-50 cm from the ground; in the case of vegetable crops in open fields, the threads can be laid at a varying height depending on the crop, preferably at 30-50 cm from the ground and tied to stakes fixed to the ground at distances preferably ranging from 20 to 30 metres.

The control of the insect species harmful for agrarian crops, is effected by installing a total length of between 200 and 2,000 metres of thread per hectare, preferably from 500 to 1,500 metres per hectare.

In this way, the quantity of principle used varies from 2.5 to 120 g/hectare, preferably from 5 to 75 g/ha, even more preferably from 10 to 25 g/ha. These latter preferred dosage ranges, typical of the disorientation method rather than sexual confusion, have the further advantage of being able to fight insects using lower quantities of pheromones thus reducing the impact that is verified, on the contrary, with saturation of the environment with quantities of active principle in the order of 75-100 g/ha (typical of sexual confusion).

The following examples are provided, for purely illustrative and non-limiting purposes, for a better understanding of the present invention.

### EXAMPLE 1

75 grams of pheromone blend for Cydia molesta, consisting of Z8-12:Ac, Z8-12:OH and E8-12:Ac, in a ratio of 92:1:7, 0.75 grams of Antiox 640 and 0.75 grams of Chimassorb 81, are dissolved in 3 litres of dichloromethane, to obtain a solution containing 25 mg/ml of pheromone blend.

A bobbin of paper thread having a diameter of 1.5 mm and a length of 1,680 metres, is placed in a cylindrical container; the solution previously prepared is poured onto the bobbin and is left to absorb for a total of five minutes. The bobbin is extracted from the container, dripped and left to dry under suction.

### EXAMPLE 2

50 grams of pheromone blend for Spodoptera littoralis, consisting of Z,E-9, 11-14:Ac and Z,E-9, 12-14:Ac, in a ratio of 95:5, 0.5 grams of Antiox 640 and 0.5 grams of Chimassorb 81, are dissolved in 2 litres of dichloromethane, to obtain a solution containing 25 mg/ml of pheromone blend.

A bobbin of paper thread having a diameter of 1.5 mm and a length of 1,680 metres, is placed in a cylindrical container; the solution previously prepared is poured onto the bobbin and is left to absorb for a total of five minutes. The bobbin is extracted from the container, dripped and left to dry under suction.

### EXAMPLE 3

62.50 grams of pheromone blend for Spodoptera littoralis and Spodoptera exigua, consisting of Z,E-9, 11-14:Ac, Z,E-9, 12-14:Ac and Z9-14:Ac, in a ratio of 89:10:1, 0.62 grams of Antiox 640 and 0.62 grams of Chimassorb 81, are dissolved in 2.5 litres of dichloromethane, to obtain a solution containing 25 mg/ml of pheromone blend.

A bobbin of paper thread having a diameter of 1.5 mm and a length of 1,630 metres, is placed in a cylindrical container; the solution previously prepared is poured onto the bobbin and is left to absorb for a total of five minutes. The bobbin is extracted from the container, dripped and left to dry under suction.

### EXAMPLE 4

56.51 grams of pheromone blend for Spodoptera littoralis and Spodoptera exigua, consisting of Z,E-9, 11-14:Ac, Z,E-9, 12-14:Ac and Z9-14:Ac, in a ratio of 47.5:47.5:5, 0.56 grams of Antiox 640 and 0.56 grams of Chimassorb 81, are dissolved in 2.5 litres of dichloromethane, to obtain a solution containing 23 mg/ml of pheromone blend.

A bobbin of paper thread having a diameter of 1.5 mm and a length of 1,630 metres, is placed in a cylindrical container; the solution previously prepared is poured onto the bobbin and is left to absorb for a total of five minutes. The bobbin is extracted from the container, dripped and left to dry under suction.

### EXAMPLE 5

The paper thread, prepared according to example 1, is coated with biodegradable material MATER-BI®, industrial grade NF01U, by passing it through an extruder, whose nozzle is at a temperature of 140° C. and at a rate of about 12-13 metres/minute. In this way, the thickness of the coating material proves to be 0.7 mm. The coated thread thus obtained is wound into bobbins of about 100 metres each.

### EXAMPLE 6

The paper thread, prepared according to example 2, is coated with biodegradable material MATER-BI®, industrial grade NF01U, by passing it through an extruder, whose nozzle is at a temperature of 140° C. and at a rate of about 13-14 metres/minute. In this way, the thickness of the coating material proves to be 0.7 mm. The coated thread thus obtained is wound into bobbins of about 100 metres each.

### EXAMPLE 7

The paper thread, prepared according to example 2, is coated with biodegradable material MATER-BI®, industrial grade NF01U, by passing it through an extruder, whose nozzle is at a temperature of 140° C. and at a rate of about 13-14 metres/minute. The thickness of the coating material is regulated at 1 mm. The coated thread thus obtained is wound into bobbins of about 100 metres each.

### EXAMPLE 8

The paper thread, prepared according to example 2, is coated with biodegradable material MATER-E1 ®, industrial grade CF03A, by passing it through an extruder, whose nozzle is at a temperature of 150° C. and at a rate of about 13-14 metres/minute. The thickness of the coating material is regulated at 1 mm. The coated thread thus obtained is wound into bobbins of about 100 metres each.

### EXAMPLE 9

The paper thread, prepared according to example 3, is coated with biodegradable material MATER-BI®, industrial grade CF03A, by passing it through an extruder, whose nozzle is at a temperature of 150° C. and at a rate of about 13-14 metres/minute. The thickness of the coating material is regulated at 0.8 mm. The coated thread thus obtained is wound into bobbins of about 100 metres each.

### EXAMPLE 10

The paper thread, prepared according to example 4, is coated with biodegradable material MATER-BI®, industrial grade CF03A, by passing it through an extruder, whose nozzle is at a temperature of 150° C. and at a rate of about 13-14 metres/minute. The thickness of the coating material is regulated at 0.8 mm. The coated thread thus obtained is wound into bobbins of about 100 metres each.

### EXAMPLE 11

Pieces of thread prepared according to the previous examples 1 and 2, having a length equal to 30 cm, are left to soak for four hours in 20 ml of tetrahydrofuran containing 0.2 mg/ml of n-hexadecanol as internal standard. The samples are centrifuged at 3,000 revs/min for 15 minutes and the supernatant is analyzed by gaschromatography.

The results are indicated in Table 1

TABLE 1

| | Content found | Theoretical content |
|---|---|---|
| Example | (mg/metre) | (mg/metre) |
| 1 | 24.03 | 25.00 |
| 2 | 23.85 | 25.00 |

### EXAMPLE 12

Pieces of thread prepared according to the previous examples 5, 6, 7, 8, 9 and 10, having a length equal to 30 cm, are left to soak for a night in 20 ml of tetrahydrofuran containing 0.2 mg/ml of n-hexadecanol as internal standard. The samples are centrifuged at 4,500 revs/min for 15 minutes and the supernatant is analyzed by gas chromatography.

The results are indicated in Table 2

TABLE 2

| | Content found | Theoretical content |
|---|---|---|
| Example | (mg/metre) | (mg/metre) |
| 5 | 22.97 | 25.00 |
| 6 | 23.11 | 25.00 |
| 7 | 23.93 | 25.00 |
| 8 | 20.28 | 25.00 |
| 9 | 28.06 | 25.00 |
| 10 | 26.70 | 23.00 |

### EXAMPLE 13

### Control of the Population of Cydia molesta on Peach Trees

A peach orchard having a surface of 0.75 ha consisting of 397 plants of various cultivars grown in Veronese vases (plant format 6.3 m×3.0 m) was monitored with pheromone traps for Cydia molesta. The objective of the test was to lower captures in the spy traps with a consequent reduction in the couplings.

On Jul. 24, 2007, pieces of thread, prepared according to example 5, having a length of 10 metres, were installed over the whole surface, alternating them in an echelon formation (a length of thread every 3 plants) for a total of 720 metres, equal to 960 metres/ha, equivalent to a dosage of 22.05 g/ha of pheromone. From the moment of their installation until the peaches were picked, the captures of the phytophagus in the traps installed in the area being tested (Orchard A) and in a nearby orchard having the same characteristics treated with specific insecticides (Orchard B), were periodically registered. In the latter orchard a trap baited with a thread length of 5 cm was installed to verify its effective enticement (trap CM3).

The results of the registrations (average captures per trap) are indicated in Table 3.

TABLE 3

| Date | Cydia area A | Cydia area B | Cydia CM3 |
|---|---|---|---|
| 26/07/07 | 1.75 | 38.5 | 6.0 |
| 31/07/07 | 1.50 | 59.0 | 50.0 |
| 02/08/07 | 2.75 | 16.5 | 1.0 |
| 06/08/07 | 4.00 | 23.5 | 11.0 |
| 08/08/07 | 3.75 | 20.0 | 5.0 |
| 16/08/07 | 14.75 | 52.5 | 29.0 |
| 23/08/07 | 19.50 | 55.5 | 34.0 |

### EXAMPLE 14

### Control of the Population of Spodoptera littoralis on Spinach in Field

An area cultivated with spinach destined for freezing, having an overall extension of a hectare, was monitored with pheromone traps for Spodoptera littoralis. The objective of the test was to lower captures in the spy traps with a consequent reduction in the couplings and a decrease in the number of insecticide treatments necessary.

On Sep. 20, 2007, six segments of thread, prepared according to example 7, having a length equal to 100 metres were installed along the row of the crop, at 40 cm from the ground and at a distance of 20 metres from each other, fixing them to a sufficient number of rods for sustaining it, for a total of 600 m/hectare equal to 14.36 g/ha of pheromone.

From the moment of their installation until the spinach was picked, the captures of the phytophagus in the traps installed in the area being tested (Area A, four traps) and in a nearby area having the same characteristics treated with specific insecticides (Area B, four traps), were periodically registered.

The results of the registrations (average captures per trap) are indicated in Table 4.

TABLE 4

| Date | Area A | Area B |
|---|---|---|
| 4/10/07 | 7.00 | 203.25 |
| 11/10/07 | 2.00 | 65.50 |
| 17/10/07 | 0.75 | 37.75 |
| 24/10/07 | 1.25 | 21.00 |
| 30/10/07 | 1.00 | 27.50 |

### EXAMPLE 15

### Control of the Population of Spodoptera littoralis on Spinach in Field

An area cultivated with spinach destined for freezing, having an overall extension of a hectare, was monitored with pheromone traps for Spodoptera littoralis. The objective of the test was to lower captures in the spy traps with a consequent reduction in the couplings and a decrease in the number of insecticide treatments necessary.

On Sep. 20, 2007, six segments of thread, prepared according to example 8, having a length equal to 100 metres were installed along the row of the crop, at 40 cm from the ground and at a distance of 20 metres from each other, fixing them to a sufficient number of rods for sustaining it, for a total of 600 m/hectare equal to 12.17 g/ha of pheromone.

From the moment of their installation until the spinach was picked, the captures of the phytophagus in the traps installed in the area being tested (Area A, four traps) and in a nearby area having the same characteristics treated with specific insecticides (Area B, four traps), were periodically registered.

The results of the registrations (average captures per trap) are indicated in Table 5.

TABLE 5

| Date | Area A | Area B |
|---|---|---|
| 04/10/07 | 2.75 | 203.25 |
| 11/10/07 | 1.50 | 65.50 |
| 17/10/07 | 1.00 | 37.75 |
| 24/10/07 | 0.25 | 21.00 |
| 30/10/07 | 0.50 | 27.50 |
| 06/11/07 | 0.75 | 118.75 |

### EXAMPLE 16

### Control of the Population of Spodoptera littoralis on Cyclamens in a Greenhouse

A greenhouse having a surface of 1,828.40 square metres used for the cultivation of cyclamens in vases was divided into two areas: Area A, of 910.80 m² and Area B of 917.60 m².

On Aug. 20, 2007, 165.80 metres of thread, prepared according to example 7, were installed in Area A, fixing it to supporting rods of the same greenhouse at about 50 cm from the ground, for a total of 3.97 g of pheromone mixture (equivalent to 1,820 m/hectare and equal to 43.56 g/ha of pheromone).

93.70 metres of thread, prepared according to example 7, were installed in Area B, fixing it to supporting rods of the same greenhouse at about 50 cm from the ground, for a total of 2.24 g of pheromone mixture (equivalent to 1,021 m/hectare and equal to 24.44 g/ha of pheromone).

A pheromone trap for Spodoptera littoralis was installed in each Area, controlled at regular intervals of seven days. No captures of phytophagus were registered for the whole duration of the test.

From the beginning of the test, a single specific insecticide treatment was effected against S. littoralis, (September 20^{th}, Methomyl), whereas in a nearby greenhouse exclusively protected with insecticides, six specific treatments were necessary.

The final registration of the damage was effected on Oct. 24, 2007, controlling 500 (100 vases in 5 different areas) for each thesis. The result is indicated in Table 6.

TABLE 6
Number of non-sellable vases

| Area A | Area B | Area C |
|---|---|---|
| 0 | 0 | 6 |

### EXAMPLE 17

### Control of the Population of Spodoptera littoralis on Officinal Plants (Thyme, Marjoram, Rosemary) in Fields

An area cultivated with officinal plants destined for fresh consumption, having an overall extension of one hectare, was monitored with pheromone traps for Spodoptera littoralis. The objective of the test was to lower captures in the spy traps with a consequent reduction in the couplings and a decrease in the number of insecticide treatments necessary.

On Jul. 28, 2007, segments of thread, prepared according to example 8, having a variable length, were installed along the row of the crop, at 40 cm from the ground and at a distance of 20 metres from each other, fixing them to a sufficient number of rods for sustaining it, for a total of 637 m/hectare equal to 15.20 g/pa/ha.

From the moment of their installation until the end of November (end of observation), the captures of the phytophagus in the traps installed in the area being tested (Area A, four traps) and in a nearby area having the same characteristics treated with specific insecticides (Area B, four traps), were periodically registered.

The results of the registrations (average captures per trap) are indicated in Table 7.

TABLE 7

| Date | Area A | Area B |
|---|---|---|
| 28/07/07 | 19.00 | 9.00 |
| 06/08/07 | 0.50 | 0.00 |
| 08/08/07 | 0.00 | 0.00 |
| 14/08/07 | 1.67 | 14.60 |
| 22/08/07 | 2.83 | 14.00 |
| 29/08/07 | 0.17 | 2.80 |
| 08/09/07 | 0.33 | 3.40 |
| 12/09/07 | 0.00 | 0.40 |
| 19/09/07 | 0.00 | 3.20 |
| 25/09/07 | 0.00 | 0.60 |

### EXAMPLE 18

### Control of the Population of Spodoptera littoralis on Basil in Fields

An area cultivated with basil destined for fresh consumption, having an overall extension of 520 square metres, was monitored with pheromone traps for Spodoptera littoralis. The objective of the test was to lower captures in the spy traps with a consequent reduction in the couplings to limit damage to the harvesting.

On Aug. 21, 2007, 7 segments of thread, prepared according to example 8, 12 metres long, were installed along the rows of the crop, at 100 cm from the ground and at a distance of 6 metres from each other, fixing them to already existing rods, for a total of 1615 m/hectare equal to 40 g/pa/ha. The increase in dosage is due to the reduced dimension of the area.

From the moment of their installation until the end of September (end of observation), the captures of the phytophagus in the traps installed in the area being tested (Area A, one trap) and in a nearby area having the same characteristics not treated (Area B, one trap), were periodically registered.

On Sep. 24, 2007, a registration of the attack was effected, by controlling 5 groups of 100 basil leaves in different points of the area.

The results of the registrations are indicated in Table 8.

TABLE 8

| | Healthy | Damaged |
|---|---|---|
| | leaves | leaves |
| Area tested | 94.8% | 4.2% |
| Non-treated area | 58.2% | 41.8% |

### EXAMPLE 19

### Control of the Population of Spodoptera littoralis on IV Range Crops in Tunnels (Lettuce, Rocket, Valerian, Spinach)

52 multi-tunnels cultivated with IV Range crops, having an overall extension of 1.58 hectares, were monitored with pheromone traps for Spodoptera littoralis. The objective of the test was to lower captures in the spy traps with a consequent reduction in the couplings and a decrease in the number of insecticide treatments necessary.

On Jul. 10, 2007, segments of thread, prepared according to example 8, having a variable length, were installed along the rows of the crop, at 180 cm from the ground and at a distance of 16 metres from each other, fixing them to already existing structures in the tunnels, for a total of 641 m/hectare equal to 14.50 g/pa/ha.

From the moment of their installation until the end of the observations, the captures of the phytophagus in the traps installed in the area being tested (Area A, four traps) and in a nearby area having the same characteristics treated with specific insecticides (Area B, four traps), were periodically registered.

The results of the registrations (average captures per trap) are indicated in Table 9.

TABLE 9

| Date | Area A | Area B |
|---|---|---|
| 10/07/07 | 0.25 | 52.00 |
| 29/07/07 | 0.00 | 10.00 |
| 13/08/07 | 0.75 | 4.40 |
| 05/09/07 | 3.25 | 138.50 |
| 11/09/07 | 2.5 | 26.30 |
| 16/09/07 | 0.25 | 69.00 |

Three treatments with specific insecticides (Spinosad®) were effected during the two months following the installation in the test area, mainly for reducing noctuids other than Spodoptera littoralis, against the 10 treatments necessary in the company allotments.

### EXAMPLE 20

### Control of the Population of Spodoptera littoralis and Spodoptera Exigua on Spinach in Fields

An area cultivated with spinach destined for freezing, having an overall extension of 10 hectares, was monitored with pheromone traps for Spodoptera littoralis and Spodoptera exigua. The area was divided into two lots of 5 hectares (lot A and lot B). The objective of the test was to lower captures in the spy traps with a consequent reduction in the couplings and number of insecticide treatments necessary.

On Sep. 25, 2007, 25 segments of thread, prepared according to example 9, 100 metres long, were installed in lot A along the rows of the crop, at 40 cm from the ground and at a distance of 20 metres from each other, fixing them to rods in a sufficient number to sustain it, for a total of 500 m/hectare equal to 14.03 g/pa/ha.

On Sep. 25, 2007, 25 segments of thread, prepared according to example 10, 100 metres long, were installed in lot B along the rows of the crop, at 40 cm from the ground and at a distance of 20 metres from each other, fixing them to rods in a sufficient number to sustain it, for a total of 500 m/hectare equal to 13.35 g/pa/ha.

From the moment of their installation until the harvesting of the spinach, the captures of the phytophagus in the traps installed in the areas being tested (lot A four traps, lot B four traps) and in a nearby area having the same characteristics treated with specific insecticides (lot C, four traps), were periodically registered.

The results of the registrations (average captures per trap) are indicated in Table 10.

TABLE 10

| | Lot A | | Lot B | | Allotment C | |
|---|---|---|---|---|---|---|
| Date | S. littor. | S. exig. | S. littor. | S. exig. | S. littor. | S. exig. |
| Oct. 02, 2008 | 0 | 0 | 0 | 0 | 45 | 0.33 |
| Oct. 08, 2008 | 0 | 0 | 0 | 0 | 37.33 | 0.67 |
| Oct. 16, 2008 | 0 | 0 | 0.25 | 0 | 99 | 0 |
| Oct. 22, 2008 | 0 | 0 | 0.5 | 0 | 114 | 0.67 |
| Nov. 04, 2008 | 1.25 | 0 | 0.25 | 0 | 214.67 | 1.33 |
| Nov. 11, 2008 | 0.25 | 0 | 0 | 0 | 373.67 | 1.67 |
| Nov. 18, 2008 | 0 | 0 | 0 | 0 | 145.33 | 1 |

### EXAMPLE 21

### Release Kinetics

20 metres of thread coated according to examples 5-8 are exposed in the open air under field conditions, periodically sampled by removing pieces having a length of 30 cm and analyzed according to what is described in examples 11-12. In the graphics of the figures the release kinetics are shown, measured for the device of Cydia molesta of Example 5 and for the devices of Spodoptera littoralis of Examples 6-8.

1. A device for fighting insects consisting of an internal structure made of biodegradable material based on cellulose, impregnated with a volatile substance or a mixture of volatile substances, and an outer coating made of a biodegradable material based on starches and thermoplastic polymers, said device being extruded in the form of a continuous thread.

2. The device according to claim 1, wherein said volatile substance is a pheromone or a mixture of pheromones.

3. The device according to claim 2, wherein said pheromone or mixture of pheromones is specific for each of the following insects: Cydia molesta, Anarsia lineatella, Cydia funebrana, Cydia pomonella, Heliothis armigera, Lobesia botrana, Mamestra brassicae, Spodoptera exigua, Spodoptera littoralis, Spodoptera frugiperda, Heliothis armigera.

4. The device according to claim 1, wherein said volatile substance is tert-butyl (±)-4 (or 5)-chloro-2-methyl cyclohexane carboxylate specific for Ceratitis capitata.

5. The device according to claim 1, wherein the inner structure made of biodegradable material based on cellulose, has a diameter ranging from 1 to 3 mm, preferably from 1.3 to 1.6 mm.

6. The device according to claim 1, wherein said outer coating of biodegradable material based on starches and thermoplastic polymers, has a thickness of 0.2 to 3 mm, preferably from 0.7 to 1.5 mm.

7. The device according to claim 1, wherein the extruded thread has a length ranging from 20 to 200 metres, preferably from 80 to 120 metres.

8. The device according to claim 1, wherein the content of volatile substance or mixture of volatile substances per linear metre of thread ranges from 5 to 60 mg/metre.

9. The device according to claim 8, wherein the content of volatile substance or mixture of volatile substances per linear metre of thread ranges from 15 to 25 mg/metre.

10. A process for the preparation of the device according to claim 1, wherein a bobbin of cellulose-based thread is impregnated with a solution of a volatile substance or mixture of volatile substances in a low-boiling solvent by immersion for a time varying from 30 seconds to 30 minutes, at a temperature ranging from 20 to 40° C., and the impregnated thread is subsequently coated with a biodegradable material based on starches and thermoplastic polymers by extrusion at temperatures ranging from 100 to 200° C.; after cooling, the coated thread is wound into bobbins having a length varying from 20 to 200 metres.

11. The process according to claim 10, wherein said volatile substance is a pheromone or a mixture of pheromones.

12. The process according to claim 10, wherein the concentration of the impregnating solution ranges from 5 to 50 g/litre, preferably from 15 to 25 g/litre.

13. The process according to claim 10, wherein the impregnation time ranges from 2 to 15 minutes.

14. The process according to any of the claims 10-13, wherein the extrusion is effected at temperatures ranging from 140 to 160° C.

15. A method for controlling insects harmful to agrarian crops which consists in the installation in fields or greenhouses of the devices according to claim 1 for a total length ranging from 200 to 2,000 metres of thread per hectare, so that the quantity of active principle used ranges from 2.5 to 120 g/ha, preferably from 5 to 75 g/ha, even more preferably from 10 to 25 g/ha.
